(19) United States
(12) Patent Application Publication
(10) Pub. No.: US 2024/0308190 A1
(43) Pub. Date: Sep. 19, 2024

(54) PACKAGING FILM HAVING OXYGEN BARRIER

(71) Applicant: AMCOR FLEXIBLES NORTH AMERICA, INC., Neenah, WI (US)

(72) Inventor: Ankush A. GOKHALE, Fulshear, TX (US)

(21) Appl. No.: 18/572,624

(22) PCT Filed: Jun. 28, 2021
(86) PCT No.: PCT/US2021/039354

§ 371 Date: Dec. 20, 2023

(51) Int. Cl. B32B 27/08; B29C 48/00; B29C 48/10; B29C 48/18; B29C 48/21; B29C 71/04; B29K 23/00; B29K 29/00; B29K 77/00; B29L 31/00; B32B 7/12; B32B 27/16; B32B 27/30; B32B 27/32; B32B 27/34; B65B 5/04; B65D 65/40

(52) U.S. Cl. CPC B32B 27/08; B29C 71/04; B32B 7/12; B32B 27/16; B32B 27/306; B32B 27/32; B32B 27/34; B65B 5/04; B65D 65/40; B29C 48/0018; B29C 48/10; B29C 48/185; B29C 48/21; B29K 2023/06; B29K 2023/083; B29K 2023/086; B29K 2029/04; B29K 2077/00; B29K 2995/0067; B29K 2995/0069; B29L 2031/7128; B32B 2250/05; B32B 2250/24; B32B 2250/40; B32B 2307/31; B32B 2307/7244; B32B 2307/734; B32B 2307/74; B32B 2439/70; B65D 2565/387

(57) ABSTRACT

A non-shrink, irradiated packaging film includes first, second, third, and fourth layers of polyamide (PA); a first polyethylene vinyl alcohol (EVOH) layer between the first and second PA layers; a second EVOH layer between the third and fourth PA layers; a mid-layer between the second and third PA layers; and first and second polyethylene (PE) layers. The first, second, third, and fourth PA layers, the first and second EVOH layers, and the mid-layer are between the first and second PE layers. The mid-layer may be formed from a polymer.

### FIELD

The present application relates generally to packaging films having polyamide layers and poly(ethylene vinyl alcohol) (EVOH) layers that are irradiated to improve barrier properties.

### TECHNICAL BACKGROUND

Foil layers are typically employed to provide a complete or near complete barrier to oxygen transmission through multilayer films. However, foil layers are delicate and may develop pin holes, for example if the film is subjected to wrinkling, which destroys or reduces the barrier properties.

EVOH layers in multilayer film provide oxygen barrier properties. However, to achieve a complete or near complete oxygen barrier, the EVOH layers need to be thick or numerous. Because manufacturing films with thick layer is impractical and due to relative expense of EVOH, achieving complete or near complete oxygen barrier properties using EVOH layers can be challenging.

### BRIEF SUMMARY

This disclosure, among other things, relates to packaging films having polyamide layers and (EVOH) layers that are irradiated to improve barrier properties. Oxygen barrier properties of EVOH may improve when irradiated with ionizing radiation. The ionizing radiation may result in generation of free radicals in the EVOH layer. The free radicals may act as oxygen scavenger, which may improve oxygen barrier properties.

Surprisingly, the inventors found that the ability of ionizing radiation to improve barrier properties of multilayer films having an EVOH layer varied depending on the composition of other layers of the multilayer film. Some adjacent layers substantially prevented the ionizing radiation from enhancing the barrier properties of the EVOH layer, while other adjacent layers enhanced the ability of ionizing radiation to improve the barrier properties of the film.

In some aspects described herein, an irradiated packaging film comprises first, second, third, and fourth layers of polyamide; a first EVOH layer between the first and second polyamide layers; a second EVOH layer between the third and fourth polyamide layers; a mid-layer between the second and third polyamide layers, and first and second polyethylene layers. The first, second, third, and fourth polyamide layers, the first and second EVOH layers, and the mid-layer layer are between the first and second polyethylene layers.

The mid-layer may be a collapsed layer resulting from blown film coextrusion. Accordingly, the mid-layer may be formed from any suitable material as a collapsing layer for a blown film process. In some embodiments, the mid-layer is a poly(ethylene vinyl acetate) (EVA) layer.

Manufacturing the film via a blown film process may result in improved oxygen barrier properties of the film.

The film may be symmetrical. Symmetry of the film may result from a blown film coextrusion process.

The packaging film is preferably dimensionally stable. That is, the packaging film may be non-shrink.

The packaging may be used to package a food product. Accordingly, a method may include sealing a food product in the packaging film to form a packaged food product. Thus, in some embodiments, a packaged food product may include a food product packaged in the packaging film. The food product may have a water activity of 0.6 or greater, such as 0.8 or greater, or in a range from 0.8 to 1. For example, wet food products may be sealed within the packaging.

In some aspects described herein a method for manufacturing a non-shrink, irradiated packaging film, comprises coextruding first, second, third, and fourth layers of polyamide, first and second layers of EVOH; a mid-layer, and first and second polyethylene layers to produce a first film in which: the first EVOH layer is between the first and second polyamide layers, the second EVOH layer is between the third and fourth polyamide layers, the mid-layer is between the second and third polyamide layers, and the first, second, third, and fourth polyamide layers, the first and second EVOH layers, and the mid-layer are between the first and second polyethylene layers. The method further includes exposing the first film to ionizing radiation to produce an ionized first film.

Exposing the first film to ionizing radiation preferably comprises exposing the first film to a dose of ionizing radiation that results in improved oxygen barrier properties of the first film.

The coextrusion may be a blown film coextrusion process in which the mid-layer is a collapsed layer. The mid-layer may be an EVA layer.

It is to be understood that both the foregoing general description and the following detailed description present embodiments of the subject matter of the present disclosure and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic drawing of a cross-section of a non-shrink, irradiated packaging film in accordance with an embodiment described herein;

FIG. 2 is a schematic view of an embodiment of a packaged product; and

FIG. 3 is a flow diagram of an embodiment of a method for manufacturing a non-shrink, irradiated packaging film.

The schematic drawings are not necessarily to scale. Like numbers used in the figures refer to like components. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### DETAILED DESCRIPTION

Reference will now be made in greater detail to various embodiments of the subject matter of the present disclosure, some embodiments of which are illustrated in the accompanying drawings.

This disclosure, among other things, relates to packaging films having polyamide layers and (EVOH) layers that are irradiated to improve barrier properties. Oxygen barrier properties of EVOH may improve when irradiated with ionizing radiation.

The packaging films may comprise first, second, third, and fourth layers of polyamide; a first polyethylene vinyl alcohol (EVOH) layer between the first and second polyamide layers; a second EVOH layer between the third and fourth polyamide layers; a mid-layer between the second and third polyamide layers, and first and second polyethylene layers, wherein the first, second, third, and fourth polyamide layers, the first and second EVOH layers, and the mid-layer are between the first and second polyethylene layers.

The packaging film may comprise one or more tie layers. “Tie layers” are adhesive layers that may be selected to promote the adherence of adjacent layers to one another in a multilayer film and prevent undesirable delamination. A multifunctional layer is preferably formulated to aid in the adherence of one layer to another layer without the need of using separate adhesives by virtue of the compatibility of the materials in that layer to the first and second layers. In some embodiments, adhesive layers comprise materials found in both the first and second layers.

Multilayer films may comprise any suitable number of tie or adhesive layers of any suitable composition. Various adhesive layers are formulated and positioned to provide a desired level of adhesive between specific layers of the film according to the composition of the layers contacted by the tie layers.

In some embodiments, the packaging films comprise a first tie layer between the first polyethylene layer and the first polyamide layer and comprise a second tie layer between the second polyethylene layer and the second polyamide layer.

In some embodiments, the packaging film consist essentially of or consists of: first, second, third, and fourth layers of polyamide; a first polyethylene vinyl alcohol (EVOH) layer between the first and second polyamide layers; a second EVOH layer between the third and fourth polyamide layers; a mid-layer between the second and third polyamide layers, first and second polyethylene layers, and, optionally, one or more tie layers, wherein the first, second, third, and fourth polyamide layers, the first and second EVOH layers, and the mid-layer are between the first and second polyethylene layers.

In some embodiments, the packaging film consist essentially of or consists of: first, second, third, and fourth layers of polyamide; a first polyethylene vinyl alcohol (EVOH) layer between the first and second polyamide layers; a second EVOH layer between the third and fourth polyamide layers; a mid-layer between the second and third polyamide layers, first and second polyethylene layers, and first and second tie layers, wherein the first, second, third, and fourth polyamide layers, the first and second EVOH layers, the mid-layer are between the first and second polyethylene layers, the first tie layer is between the first polyethylene layer and the first polyamide layer, and the second tie layer is between the second polyethylene layer and the second polyamide layer.

As used herein, “consisting essentially of” (and any form of consisting essentially of, such as “consists essentially of” and “consist essentially of”) means the article, film, layer, composition, method, or the like includes the specified enumerated elements; such as layers, components, compounds, materials, steps, or the like, and may include additional elements that do not materially affect the basic and novel characteristics of the article, film, layer, composition, method, or the like.

In one preferred embodiment, the packaging film comprises the following layer structure: polyethylene/tie/polyamide/EVOH/polyamide/tie/EVA/tie/polyamide/EVOH/polyami de/tie/polyethylene.

The packaging films may comprise any suitable polyamide layer. As used herein, a “polyamide layer” is a layer that comprises 50% or more polyamide by weight, such as 80% or more polyamide by weight, or 90% or more polyamide by weight.

The term “polyamide” means a high molecular weight polymer having amide linkages (—CONH—)ₙ which occur along the molecular chain, and includes “nylon” resins which are well known polymers having a multitude of uses including utility as packaging films, bags, and pouches. See, e.g. Modern Plastics Encyclopedia, 88 Vol. 64, No. 10A, pp 34-37 and 554-555 (McGraw-Hill, Inc., 1987) which is hereby incorporated by reference. In some embodiments, polyamides are preferably selected from nylon compounds approved for use in producing articles intended for use in processing, handling, and packaging food or drugs.

The term “nylon,” as used herein, refers more specifically to synthetic polyamides, either aliphatic or aromatic, either in crystalline, semi-crystalline, or amorphous form characterized by the presence of the amide group —CONH. It is intended to refer to both polyamides and co-polyamides.

Thus, the terms “polyamide” or “nylon” encompass both polymers comprising repeating units derived from monomers, such as caprolactam, which polymerize to form a polyamide, as well as copolymers derived from the copolymerization of caprolactam with a comonomer which when polymerized alone does not result in the formation of a polyamide. Preferably, polymers are selected from compositions approved as safe for producing articles intended for use in processing, handling and packaging of food or drugs, such as nylon resins approved by the U.S. Food and Drug Administration provided at 21 CFR § 177.1500 (“Nylon resins”), which is incorporated herein by reference. Examples of these nylon polymeric resins for use in food or drug packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 6I/6T disclosed at 21 CFR § 177.1500. Examples of such polyamides include nylon homopolymers and copolymers such as those selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-cododecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, and hexamethylenediamine azelaic acid), nylon 11 (polyundecanolactam), nylon 12 (polylauryllactam) and copolymers or mixtures thereof.

“PA” and “polyamide” may be used interchangeably herein.

The packaging film may comprise any suitable polyethylene layer. As used herein, a “polyethylene layer” is a layer that comprises 50% or more polyethylene by weight, such as 80% or more polyethylene by weight, or 90% or more polyethylene by weight.

The term “polyethylene” is used herein (unless indicated otherwise) to refer to ethylene homopolymers as well as copolymers of ethylene with α-olefins and the term will be used without regard to the presence or absence of substituent branch groups. “PE” is used herein interchangeably with “polyethylene.”

The polyethylene may be a “low density polyethylene” (LDPE). LDPE is used to denominate branched homopolymers having densities between 0.915 and 0.930 g/cm³. LDPEs typically contain long branches off the main chain (often termed “backbone”) with alkyl substituents of 2 to 8 carbon atoms.

The polyethylene may be an EAO. EAOs are copolymers having an ethylene as a major component copolymerized with one or more alpha olefins such as octene-1, hexene-1, or butene-1 as a minor component. EAOs include polymers known as linear low density polyethylene (“LLDPE”), very low density polyethylene (“VLDPE”), ultralow density polyethylene (“ULDPE”), and plastomers and may be made using a variety of processes and catalysts including metallocene, single-site and constrained geometry catalysts as well as Ziegler-Natta and Phillips catalysts.

Linear Low Density Polyethylene (LLDPE) are copolymers of ethylene with alpha-olefins having densities from 0.915 to 0.940 g/cm³. The α-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). The LLDPE may be produced with a metallocene or constrained geometry catalyst, which may be referred to as “mLLDPE”.

Very Low Density Polyethylene (VLDPE) and “Ultra Low Density Polyethylene” (ULDPE) are copolymers of ethylene with α-olefins, usually 1-butene, 1-hexene or 1-octene and are recognized by those skilled in the art as having a high degree of linearity of structure with short branching rather than the long side branches characteristic of LDPE. However, VLDPEs have lower densities than LLDPEs. The densities of VLDPEs are recognized by those skilled in the art to range between 0.860 and 0.915 g/cm³. Sometimes VLDPEs having a density less than 0.900 g/cm³ are referred to as “plastomers”.

One or more polyethylene layers may be a seal layer. Some examples of polyethylene that may be particularly well suited for use in a seal layer herein include LDPE, VLDPE, ULDPE, LLDPE, and ethylene vinyl acetate (EVA).

As used herein, a “seal layer” is a layer capable of fusion bonding by conventional indirect heating means which generate sufficient heat on at least one film contact surface for conduction to a contiguous film contact surface and formation of a bond interface therebetween without loss of the film integrity. The bond interface between contiguous inner layers preferably has sufficient physical strength to withstand the packaging process and subsequent handling.

A seal layer preferably forms an exterior surface of the packaging film. When the packaging film is sealed to a support, such as itself or another structure, via the heat seal layer, the sealed heat seal layer may form an interior surface of the packaged product.

The packaging films may comprise any suitable mid-layer. A “mid-layer” is a layer between outer surfaces of a multilayer packaging film. The packaging film may be symmetrical or substantially symmetrical about the mid-layer.

The mid-layer may be formed from any material suitable for use as a collapsible layer in a blown film coextrusion process. That is, the material of the mid-layer may be blown coextruded and collapsed upon itself.

The mid-layer may comprise any suitable EVA. EVA is a copolymer of ethylene and vinyl acetate. EVA may comprise any suitable weight percent of ethylene and vinyl acetate. In some embodiments, the EVA comprises from about 1% to about 40% vinyl acetate by weight, such as from about 2% to about 30% vinyl acetate by weight or from about 5% to about 20% vinyl acetate by weight. In some embodiments, the EVA comprises from about 60% to about 99% ethylene by weight, such as from about 70% to about 98% ethylene by weight or from about 80% to about 95% ethylene by weight.

Examples of commercially available EVA include Escorenem™ Ultra LD 705.MJ available from ExxonMobil Chemical Company (Houston, Tex.), Escorene™ Ultra LD 768.MJ available from Exxon Mobil Chemical Company (Houston, Tex.) and Ateva® 2861 AU available from Celanese Corporation (Edmonton, Alberta, Canada).

As used herein, an “EVA layer” is a layer that comprises 50% or more EVA by weight, such as 80% or more EVA by weight, or 90% or more EVA by weight.

The packaging film may comprise any suitable EVOH layer. As used herein, an “EVOH layer” is a layer that comprises 50% or more EVOH by weight, such as 80% or more EVOH by weight, or 90% or more EVOH by weight.

As used herein, “EVOH” refers to ethylene vinyl alcohol copolymer. EVOH is otherwise known as saponified or hydrolyzed ethylene vinyl acetate copolymer and refers to a vinyl alcohol copolymer having an ethylene comonomer. EVOH is prepared by the hydrolysis (or saponification) of an ethylene-vinyl acetate copolymer. The degree of hydrolysis is preferably from about 50 to 100 mole percent, more preferably, from about 85 to 100 mole percent, and most preferably at least 97%. Greater degrees of hydrolysis (e.g., 97% or more) produce a more effective oxygen barrier.

EVOH is commercially available in resin form with various percentages of ethylene, and there is a direct relationship between ethylene content and melting point. For example, EVOH having a melting point of about 175° C. or lower is characteristic of EVOH materials having an ethylene content of about 38 mole percent (mol %) or higher. EVOH having an ethylene content of 38 mol % has a melting point of about 175° C. With increasing ethylene content, the melting point is lowered. Also, EVOH polymers having increasing mole percentages of ethylene have greater gas permeabilities. A melting point of about 158° C. corresponds to an ethylene content of 48 mol %. EVOH copolymers having lower or higher ethylene contents may also be employed. It is expected that processability and orientation would be facilitated at higher contents; however, gas permeabilities, particularly with respect to oxygen, may become undesirably high for certain packaging applications which are sensitive to microbial growth in the presence of oxygen. Conversely lower contents may have lower gas permeabilities, but processability and orientation may be more difficult.

Examples of commercially available EVOH include resins available from Eval Company of America under the tradename Eval™. Examples of commercially available EVOH films include Eval™ EF-E, Eval™ EF-F, and Eval™ EF-XL, available from Eval Company of America.

Exposing EVOH layers to ionizing radiation may increase its oxygen barrier properties. Without intending to be bound by theory, it is believed that exposing the EVOH to ionizing radiation generates free radicals within the EVOH, and the free radicals act as an oxygen absorber.

Surprisingly, the inventors found that the ability of ionizing radiation to improve oxygen barrier properties (e.g., reduction of oxygen transmission rate) of multilayer films having an EVOH layer varied depending on the composition of other layers of the multilayer film. Some adjacent layers substantially prevented the ionizing radiation from enhancing the barrier properties of the EVOH layer, while other adjacent layers enhanced the ability of ionizing radiation to improve the barrier properties of the film.

Ionizing radiation is radiation that has sufficient energy to remove electrons from atoms, causing the atom to become charged or ionized. Ionizing radiation may consist of electromagnetic waves or subatomic particles. Sources of ionizing radiation include electron beam (e-beam) and gamma ray radiation sources. Electron beam radiation is preferred.

Dosages of radiation required to effect the desired reduction in oxygen transmission of the packaging film are preferably in the range of about 1 Mrads to about 20 Mrads, more preferably in the range of about 5 Mrads to about 15 Mrads. Increasing radiation levels may produce an increase in duration of the reduction in oxygen transmission. However, in some cases, increased radiation levels may reduce barrier efficacy. Irradiation is preferably carried out in an inert atmosphere, i.e., non-oxygen-containing atmosphere, such as, for example, a nitrogen or argon atmosphere.

Preferably, exposure of the packaging film to the ionizing radiation results in oxygen transmission of less than 0.3 cm³/m²/24 hours of the packaging film when measured according to ASTM D3985-17, Standard Test Method for Oxygen Gas Transmission Rate Through Plastic Film and Sheeting Using a Coulometric Sensor, ASTM International, West Conshohocken, PA, 2017, when measured 24 hours after irradiating the packaging film. More preferably, exposure of the packaging film to the ionizing radiation results in oxygen transmission of less than 0.2 cm³/m²/24 hours of the packaging film such as less than 0.1 cm³/m²/24 hours of the packaging film or zero (0) cm³/m²/24 hours of the packaging film when measured 24 hours after irradiating the packaging film. Preferably, the packaging film has such oxygen transmission rates (less than 0.03 cm³/m²/24 hours, less than 0.2 cm³/m²/24 hours, less than 0.1 cm³/m²/24 hours, or 0 cm³/m²/24 hours) when measured 48 hours or more after irradiation of the packaging film, such as 96 hours or more after irradiation of the packaging film, 1 week or more after irradiation of the packaging film, or one month or more after irradiation of the packaging film. The irradiated packaging film may be stored under dry conditions following irradiation until tested for oxygen transmission. The irradiated packaging film may be stored under reduced oxygen conditions following irradiation until tested for oxygen transmission. The irradiated films may be vacuum packed and stored until being subjected to oxygen transmission testing.

Exposure of the first film to ionizing radiation may result in an increase in free radicals in the first film. In some embodiments, the concentration of free radicals in the first film, or in a recyclable packaging film comprising the irradiated first film, is greater than 1×10¹⁷ spins per gram of EVOH, such as 1×10¹⁶ spins per gram of EVOH, 1×10¹⁵ spins per gram of EVOH, or 1×10¹⁴ spins per gram of EVOH. In some embodiments, the concentration of free radicals in the first film or in the recyclable. The concentration of free radicals may be measured via electron spin resonance spectroscopy. For example, the concentration of free radicals may be measured as described in L. Wall. “Electron Spin Resonance Studies of Free Radicals in Irradiated Materials,” in Materials in Nuclear Applications, (West Conshohocken, PA: ASTM International, 1960), 208-223, https://doi.org/10.1520/STP39598S. The concentration of entrapped free-radicals may be measured on the irradiated films by electron spin resonance (ESR) using a Bruker EMX X-band spectrometer. Immediately after irradiation, the film specimens may be vacuum packed in foil pouches to limit exposure to oxygen. Samples may be stored at ambient conditions. ESR measurements may also be made at ambient conditions. ESR may be calibrated using 2,2-diphenyl-1-picrylhydrazyl (DPPH) stable free radical solution. Entrapped radicals in EVOH may be detected on the ESR between magnetic fields ranging from 3400 Gauss and 3576 Gauss.

The concentration of free radicals in irradiated EVOH may decrease over time. As the concentration of free radicals decreases, the oxygen barrier properties of irradiated EVOH may be reduced (e.g., the oxygen transmission rate may increase).

Various additives may be included in the polymers utilized in one or more layers of the packaging film. Conventional antiblock additives, polymeric plasticizers, acid, moisture or gas (such as oxygen) scavengers, slip agents, colorants, dyes, pigments, organoleptic agents may be added to one or more film layers of the film or the film or one or more layers may be free from such added ingredients. Preferably, the EVOH layers are free from additives, such as anti-oxidants or gas scavengers, that may reduce the concentration of free radicals and counteract the effects of ionizing radiation. The packaging film or layers adjacent the EVOH layers may be free from additives that may reduce the concentration of free radicals.

A packaging film described herein may have any suitable thickness. In some embodiments, the packaging film has a total thickness of less than about 50 mil (1270 micrometers), more preferably the film has a total thickness of from about 1.0 mil (25.4 micrometers) to about 10 mil (254 micrometers), such as from about 1 mil (25.4 micrometers) to about 5 mil (127 micrometers), or from about 2 mil (50.8 micrometers) to about 3.5 mil (88.9 micrometers). For example, entire packaging film or any single layer of a packaging film may have any suitable thicknesses, including 1, 2, 3, 4, 5, 6, 7, 8, 9, 10, or 50 mil, or any increment of 0.1 or 0.01 mil therebetween.

In some embodiments, the packaging films are as thick as 50 mil (1270 micrometers) or higher, or as thin as 1 mil (25.4 micrometers) or less. In various embodiments, the packaging film have a thickness of between about 2 mil (50.8 micrometers) to about 4 mil (101.6 microns).

The packaging film is dimensionally stable. In some embodiments, the packaging film has a has a shrink value less than 20% in both the machine direction and the transverse direction when tested according to ASTM D2732-14(2020), Standard Test Method for Unrestrained Linear Thermal Shrinkage of Plastic Film and Sheeting, ASTM International, West Conshohocken, PA, 2020, using a bath temperature of 90 degrees Celsius. Preferably, the packaging film has a shrink value less than 10% in both the machine direction and the transverse direction, such as less than 7%, less than 5%, less than 3%, or less than 2%.

Exposure of an EVOH layer to high relative humidity, such as 65% or greater, 80% or greater, or 90% or greater, may reduce the oxygen barrier properties (e.g., increase the oxygen transmission rate) through the EVOH layer. Accordingly, the polyamide layers, between which the EVOH layers are disposed may serve to protect the EVOH layer from moisture ingress.

In some embodiments, the packing films described herein may be used to package products, such as food products. The products may be wet products, such as wet food products. At least in part because of the moisture resistant properties of the polyamide layers, the packaging films described herein may be used to package wet products despite the use of EVOH as an oxygen barrier layer.

The packaging films described herein may advantageously be employed to package products, such as food products, having a water activity of 0.6 or greater, such as 0.8 or greater. In some embodiments, the packaging films described herein are used to package products, such as food products, having a water activity in a range from 0.8 to 1.

Examples of food products that may have such water activity include tomato sauce, avocado paste, and pre-cooked macaroni and cheese.

Water activity is the ratio of water vapor pressure of a sample to water vapor pressure of pure water under the same conditions. Water activity is also equal to the equilibrium relative humidity, ERH (expressed in %), divided by 100. Accordingly, water activity is a unitless value.

Water activity may be measured by placing the sample into a closed chamber, equilibrating the liquid-phase water in the sample with the vapor-phase water in the headspace, and measuring the relative humidity of the headspace.

Instruments that may be used to measure water activity include capacitance sensors and equipment with chilled-mirror dewpoint systems. Suppliers of water activity analysis instruments include: Decagon; Novasina AG; and Rotronic Instrument Corp.

Water activity may be measured according to ISO 18787:2017 Foodstuffs—Determination of water activity. ISO 18787:2017 establishes basic principles and specifies requirements for the methods of determining water activity (aw) of food products for human consumption within a measurement range of 0 to 1. The measurement principles are based on the dew-point measurement or on the determination of the change in electrical conductivity of an electrolyte or in the permittivity of a food product.

In some embodiments, the packaging film is free of printing material, such as ink. In some embodiments, the packaging film may comprise an additional layer.

The additional layer, if present, may be laminated to the first or second polyethylene layer. Where lamination is carried out after irradiation, adhesives are preferably used. Lamination methods requiring the use of elevated temperatures are generally not preferred when lamination is carried out after irradiation as exposure to high temperature may reduce the improved oxygen barrier properties achieved through irradiation.

The additional layer may be a layer suitable for receiving printing material. The additional layer may be printed. Preferably, the additional layer is reverse printed such that the printing material is disposed on the side of the second film that contacts or is closest to the polyethylene layer to which it is laminated.

Examples of films or layers for receiving printing material include oriented polypropylene films or layers, such as a biaxially oriented polypropylene (BOPP) films or layers and polyethylene terephthalate (PET).

The additional layer may be an outer layer of the packaging film. That is, when the packaging film is used to seal a product to form a packaged product, a surface of the additional layer may be an exterior surface of the packaged product.

Since the outer layer of the packaging film may be seen by a user, the exterior surface of the outer layer of the packaging film preferably has desirable optical properties such as matte or gloss effects. Also, the exterior surface of the outer layer preferably withstands contact with sharp objects and provides abrasion resistance.

The exterior surface layer should be easy to machine (i.e., be easy to feed through and be manipulated by machines, e.g., for conveying, packaging, printing or as part of the film or packaging manufacturing process). Suitable stiffness, flexibility, flex crack resistance, modulus, tensile strength, coefficient of friction, printability, and optical properties are also frequently designed into exterior layers by suitable choice of materials. This layer may also be chosen to have characteristics suitable for creating desired heat seals which may be resistance to burn through, e.g., by impulse sealers or may be used as a heat-sealing surface in certain package embodiments, e.g., using overlap seals. The second film may be oriented, e.g., uni-axially or bi-axially oriented.

When the film does not comprise the additional layer, the first or second polyethylene layers may be an outer layer of the packaging film.

The packaging films described herein may be made in any suitable manner, such as by conventional processes. Processes to produce flexible films may include, e.g., cast or blown film processes, or extruding processes. Preferably, the process for manufacturing the packaging film includes blown film coextrusion.

Preferably, the first, second, third, and fourth layers of polyamide (PA); the EVOH layer between the first and second PA layers; the second EVOH layer between the third and fourth PA layers; the mid-layer between the second and third PA layers, the first and second polyethylene (PE) layers, and any optional tie layers are co-extruded. Preferably, the layers are coextruded in a blown film process where the mid-layer is collapsed upon itself.

The resulting film may be a palindromic symmetrical film having the following layer structure: PE/PA/EVOH/PA/mid-layer/PA/EVOH/PA/PE. To produce such a film, a non-symmetrical layers of PE/PA/EVOH/PA/mid-layer may be coextruded via a blown film process with the mid-layer collapsing upon itself to produce the packaging film.

One example layer structure of a packaging film comprising tie layers has the following layer structure: PE/tie/PE/EVOH/PA/tie/mid-layer/tie/PA/EVOH/PE/tie/PE.

The mid-layer is preferably an EVA layer.

An additional layer may be laminated to one of the PE layers. An adhesive, which forms a tie layer, may be used to laminate the additional layer to the PE layer.

The packaging film may be irradiated before or after lamination of the additional layer.

Packages may be formed from the packaging films in any suitable manner. For example, the packages may be formed by heat sealing a polyethylene seal layer of the film to a substrate. The substrate may comprise, for example, the film itself, another suitable film, or another suitable structure. In some embodiments, the packaging film is heat sealed across an opening of a container.

A packaged product may comprise a product, a packaging film as described herein, and optionally a packaging structure. The packaging film may be heat sealed to itself or the package structure to define an interior space. The product may be disposed in the interior space.

With the above general discussion in mind, reference in now made to the embodiments shown in the figures.

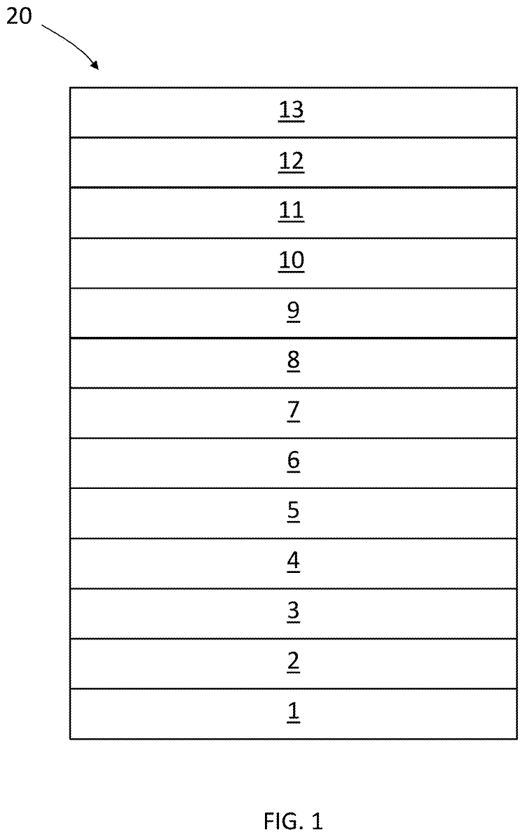

Referring to FIG. 1, a schematic drawing of a cross-section of a non-shrink, irradiated packaging film 20 in accordance with an embodiment described herein. In the depicted embodiment, the non-shrink, irradiated packaging film 20 includes thirteen layers as follows: polyethylene (PE) layer 1, tie layer 2, polyamide (PA) layer 3, EVOH layer 4, PA layer 5, tie layer 6, EVA layer 7, tie layer 8, PA layer 9, EVOH layer 10, PA layer 11, tie layer 12, and PE layer 13. One layer 13 is an outer layer, and the other PE layer 1 is an inner layer and may be seal layer. The film 20 is symmetrical around the EVA layer 7. The film may be coextruded via a blown film process with the EVA layer 7 as the collapsed layer. The film may be irradiated with E-beam radiation to produce free radicals in the EVOH layers 4, 10.

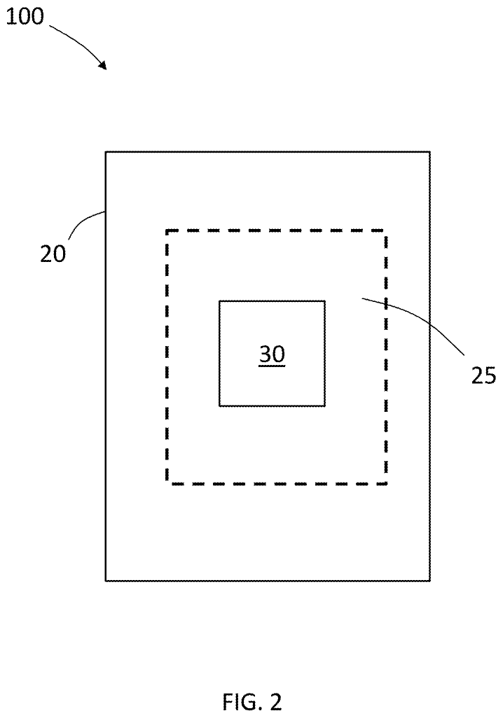

Referring now to FIG. 2, a schematic view of an embodiment of a packaged product 100 is shown. In the depicted embodiment, the packaged product 100 includes a product 20 sealed in a film 30 as described herein. The dashed lines in FIG. 2 represent the boundaries of an interior volume 25 formed by the film 20 (in this case, wrapped around the product 20 and sealed around the perimeter). The product 30 may be a food product, such as a wet food product.

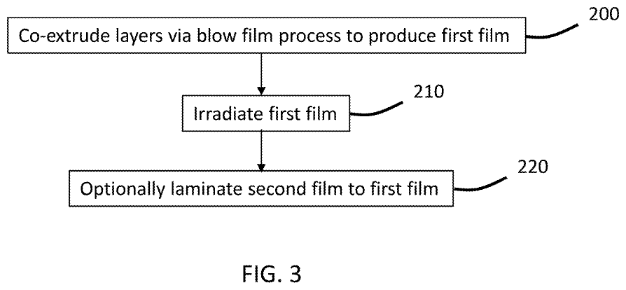

Referring now to FIG. 3, a flow diagram illustrating an embodiment of a method for manufacturing a non-shrink, irradiated packaging film is shown. The method includes coextruding layers via a blown film process to produce a first film (200). The first film may have layers as described above regarding FIG. 1. The method further includes exposing the first film to ionizing radiation (210). The first film may be exposed to sufficient ionizing radiation, such as e-beam radiation, to enhance the oxygen barrier properties of the first film. A second film may optionally be laminated to the first film (220). While the step of laminating the second film to the first film is shown in FIG. 3 as being after the first film has been irradiated, the second film may be laminated to the first film prior to exposure to radiation.

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all of the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open-ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

For purposes of the present disclosure, recitations of numerical ranges by endpoints include all numbers subsumed within that range (e.g., 1 to 5 includes 1, 1.5, 2, 2.75, 3, 3.80, 4, 5, etc.). Where a range of values is “greater than”, “less than”, etc. a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

As used herein, “providing” an article, such as a film, means to make, purchase, or otherwise obtain the article.

The term “layer” refers to a discrete component of a film that has a substantially uniform composition. A layer may or may not be coextensive with the film.

As used herein, a “polymer” refers to a material that is the product of polymerization or copolymerization of natural, synthetic or combined natural and synthetic monomers or co-monomers, or monomers and co-monomers, and is inclusive of homopolymers, copolymers, terpolymers, and the like. A layer may comprise a single polymer, a mixture of a polymer and non-polymeric material, a combination of two or more polymers blended together, or a mixture of two or more polymers and non-polymeric material.

A “polyethylene,” “polyamide,” “EVA, “EVOH,” or the like are inclusive of not only polymers comprising repeating units derived from monomers known to polymerize to form a polymer of the named type, but are also inclusive of comonomers, as well as both unmodified and modified polymers made by e.g. derivatization of a polymer after its polymerization to add functional groups or moieties along the polymeric chain. Furthermore, terms identifying polymers are also inclusive of “blends” of such polymers.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a film comprising polyethylene layers, polyamide layers, EVOH layers, and an EVA layer include embodiments where the film consists of a polyethylene layers, polyamide layers, EVOH layers, and an EVA layer and embodiments the film consists essentially of polyethylene layers, polyamide layers, EVOH layers, and an EVA layer.

A number of examples of packaging film and methods have been described herein. A non-exhaustive list of non-limiting examples are listed below. Any one or more of the features of these examples may be combined with any one or more features of another example or aspect described herein.

Example Ex1: A non-shrink, irradiated packaging film, comprising: first, second, third, and fourth layers of polyamide (PA); a first polyethylene vinyl alcohol (EVOH) layer between the first and second PA layers; a second EVOH layer between the third and fourth PA layers; a mid-layer between the second and third PA layers, the mid-layer comprising a polymer, and first and second polyethylene (PE) layers, wherein the first, second, third, and fourth PA layers, the first and second EVOH layers, and the mid-layer are between the first and second PE layers.

Example Ex2: A non-shrink, irradiated packaging film of Example Ex1, consisting essentially of the first, second, third and fourth layers of PA, the first and second EVOH layers, the EVA layer, the first and second PE layers, and, optionally, one or more tie layers.

Example Ex3: A non-shrink, irradiated packaging film of Example Ex1 or Example Ex2, comprising one or more tie layers.

Example Ex4: The non-shrink, irradiated packaging film of Example Ex1 or Example Ex2, further comprising: a first tie layer between the first PE layer and the first PA layer; and a second tie layer between the second PE layer and the fourth PA layer.

Example Ex5: The non, shrink irradiated packaging film of any one of Examples Ex1 to Ex4, wherein the mid-layer comprises ethylene vinyl acetate (EVA).

Example Ex6: The non-shrink, irradiated packaging film of any one of Examples Ex1 to Ex5, wherein the packaging film has a shrink value less than 10% in both the machine direction and the transverse direction when tested according to ASTM D2732 using a bath temperature of 90 degrees Celsius.

Example Ex7: The non-shrink, irradiated packaging film of Example Ex6, wherein the packaging film has a shrink value less than 7% in both the machine direction and the transverse direction.

Example Ex8: The non-shrink, irradiated packaging film of Example Ex6, wherein the packaging film has a shrink value less than 5% in both the machine direction and the transverse direction.

Example Ex9: The non-shrink, irradiated packaging film of Example Ex6, wherein the packaging film has a shrink value less than 3% in both the machine direction and the transverse direction.

Example Ex10: The non-shrink, irradiated packaging film of Example Ex6, wherein the packaging film has a shrink value less than 2% in both the machine direction and the transverse direction.

Example Ex11: The non-shrink, irradiated packaging film of any one of Examples Ex1 to Ex10, wherein the film is symmetrical.

Example Ex12: The non-shrink, irradiated packaging film of any one of Examples Ex1 to Ex11, wherein the film is substantially free of printing material.

Example Ex13: The non-shrink, irradiated packaging film of any one of Examples Ex1 to Ex10, comprising an additional layer, wherein the additional layer, relative to the other layers of the film, is positioned closest to the first PE layer or the second PE layer

Example Ex14: The non-shrink, irradiated packaging film of Example Ex13, wherein the additional layer is laminated to the first PE layer or the second PE layer.

Example Ex15: The non-shrink, irradiated packaging film of Example Ex13 or Ex14, wherein the film comprises printing material.

Example Ex16: The non-shrink, irradiated packaging film of Example Ex15, wherein the printing material is on the additional layer.

Example Ex17: The non-shrink, irradiated packaging film according to any one of Examples Ex1 to Ex16, wherein the packaging film has an oxygen transmission of less than 0.3 cm³/m²/24 hours when measured according to ASTM D3985-17, Standard Test Method for Oxygen Gas Transmission Rate Through Plastic Film and Sheeting Using a Coulometric Sensor, ASTM International, West Conshohocken, PA, 2017 within 24 hours after irradiating the packaging film.

Example Ex18: The non-shrink, irradiated packaging film according to Example Ex17, wherein the packaging film has an oxygen transmission of less than 0.1 cm³/m²/24 hours.

Example Ex19: The non-shrink, irradiated packaging film according to Example Ex17, wherein the packaging film has an oxygen transmission of zero (0) cm³/m²/24 hours.

Example Ex20: The non-shrink, irradiated packaging film according to any one of Examples Ex1 to Ex19 wherein the packaging film has an oxygen transmission of less than 0.3 cm³/m²/24 hours when measured according to ASTM D3985-17, Standard Test Method for Oxygen Gas Transmission Rate Through Plastic Film and Sheeting Using a Coulometric Sensor, ASTM International, West Conshohocken, PA, 2017 one week after the packaging film is irradiated.

Example Ex21: The non-shrink, irradiated packaging film according to Example Ex20, wherein the packaging film has an oxygen transmission of less than 0.1 cm³/m²/24 hours.

Example Ex22: The non-shrink, irradiated packaging film according to Example Ex20, wherein the packaging film has an oxygen transmission of zero (0) cm³/m²/24 hours.

Example Ex23: The non-shrink, irradiated packaging film according to any one of Examples Ex1 to Ex22, wherein the packaging film has an oxygen transmission of less than 0.3 cm³/m²/24 hours when measured according to ASTM D3985-17, Standard Test Method for Oxygen Gas Transmission Rate Through Plastic Film and Sheeting Using a Coulometric Sensor, ASTM International, West Conshohocken, PA, 2017 one month after the packaging film is irradiated.

Example Ex24: The non-shrink, irradiated packaging film according to Example Ex23, wherein the packaging film has an oxygen transmission of less than 0.1 cm³/m²/24 hours.

Example Ex25: The non-shrink, irradiated packaging film according to Example Ex23, wherein the packaging film has an oxygen transmission of zero (0) cm³/m²/24 hours.

Example Ex26: The non-shrink, irradiated packaging film of any one of Examples Ex1 to Ex25 for use in packaging a food product.

Example Ex27: The non-shrink, irradiated packaging film of Example Ex26, wherein the food product has a water activity of greater than 0.6.

Example Ex28: The non-shrink, irradiated packaging film of Example Ex26 for use in packaging food products having a water activity of greater than 0.8.

Example Ex29: The non-shrink, irradiated packaging film of Example Ex26 for use in packaging food products having a water activity of in a range from 0.8 to 1.

Example Ex30: The non-shrink, irradiated packaging film of Example Ex26, wherein the food product comprises tomato sauce, avocado paste, or pre-cooked macaroni and cheese.

Example Ex31: A method comprising: providing the non-shrink, irradiated packaging film according to any one of Examples Ex1 to Ex25; providing a food product; and sealing the food product in the packaging film to form a packaged food product.

Example Ex32: The method of Example Ex31, wherein the food product has a water activity of greater than 0.6.

Example Ex33: The method of Example Ex31, wherein the food product has a water activity of greater than 0.8.

Example Ex34: The method of Example Ex31, wherein the food product has a water activity of in a range from 0.8 to 1.

Example Ex35: The method of any one of Examples Ex31 to Ex34, wherein the food product comprises tomato sauce, avocado paste, or pre-cooked macaroni and cheese.

Example Ex36: A package food product, comprising: the non-shrink, irradiated packaging film of any one of the Examples Ex1 to Ex25; and a food product packaged in the packaging film.

Example Ex37: The packaged food product of Example Ex36, wherein the food product is sealed in the non-shrink, irradiated packaging film.

Example Ex38: The packaged food product of Example Ex36 or Ex37, wherein the food product has a water activity greater than 0.6.

Example Ex39: The packaged food product of Example Ex36 or Ex37, wherein the food product has a water activity greater than 0.8.

Example Ex40: The packaged food product of Example Ex36 or Ex37, wherein the food product has a water activity in a range from 0.8 to 1.

Example Ex41: The packaged food product according to any one of Examples Ex36 to Ex40, wherein the food product comprises tomato paste, avocado paste, or pre-cooked macaroni and cheese.

Example Ex42: A method for manufacturing a non-shrink, irradiated packaging film, comprising: coextruding first, second, third, and fourth layers of polyamide (PA), first and second layers of polyethylene vinyl alcohol (EVOH); a mid-layer, and first and second polyethylene (PE) layers to produce a first film in which: the first EVOH layer is between the first and second PA layers, the second EVOH layer is between the third and fourth PA layers, the mid-layer is between the second and third PA layers, and the first, second, third, and fourth PA layers, the first and second EVOH layers, and the mid-layer are between the first and second PE layers; and exposing the first film to ionizing radiation to produce an ionized first film.

Example Ex43: The method of Example Ex42, comprising co-extruding a first tie layer between the first PE layer and the first PA layer; and co-extruding a second tie layer between the second PE layer and the fourth PA layer.

Example Ex44: The method of Example Ex42 or Ex43, wherein the mid-layer comprises ethylene vinyl acetate (EVA).

Example Ex45: The method of any one of Example Ex43 or Ex44, wherein coextruding the layers comprises coextruding the layers via a blown film process.

Example Ex46: The method of Example Ex45, wherein the mid-layer is a collapsed layer.

Example Ex47: The method of any one of Example Ex42 to Ex47, comprising laminating a second film to the irradiated first film.

Example Ex48: The method of Example Ex47, wherein the second film comprises printing material.

Example Ex49: The method of Example Ex47, comprising printing material on the second film.

Example Ex50: The method of Example Ex48, wherein the material is printed on the second film before the second film is laminated to the irradiated first film.

Example Ex51: The method of any one of Examples Ex42 to Ex50, wherein exposing the first film to ionizing radiation comprises exposing the first film to a dose of radiation sufficient to increase a barrier property of the first film.

Example Ex52: The method of Example Ex51, wherein the barrier property is an oxygen transmission property.

Example Ex53: The method of Example Ex51, wherein the barrier property is water vapor transmission property.

Example Ex54: The method of any one of Examples Ex41 to Ex53, wherein exposing the first film to ionizing radiation comprises exposing the first film electron beam radiation.

Following are examples given to illustrate the invention, but these examples should not be taken as limiting the scope. All percentages are by weight unless indicated otherwise.

### Examples

A seven layer blown film was produced with EVOH comprising 29 mol % ethylene content with the following layers; PE/tie/PA/EVOH/PA/tie/EVA. The film was collapsed to produce a thirteen layer structure using the EVA as the collapsing layer to form: PE/tie/PA/EVOH/PA/tie/EVA/tie/PA/EVOH/PA/tie/PE. The tie layers comprised a maleic anhydride grafted to polyethylene.

The thirteen layer film were subjected to 200 kV electron beam radiation at a 9 Mrad dosage. Irradiated and non-irradiated films were tested for oxygen transmission at two relative humidity conditions. The first condition was at 50% RH on one side and 90% RH on the other side of the film. The second condition was at 80% RH on both sides of the film. The results are shown in Table 1.

TABLE 1

| Example | Condition | OTR (cc/m²/day) |
|---|---|---|
| Non-Irradiated | 50% RH/90% RH | 0.3 |
| Irradiated | 50% RH/90% RH | 0.0 |
| Non-Irradiated | 80% RH/80% RH | 0.8 |
| Irradiated | 80% RH/80% RH | 0.0 |

Thus, films, layers, packages, packaged products, and methods for PACKAGING FILMS HAVING OXYGEN BARRIER are described. Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in film manufacturing or related fields are intended to be within the scope of the following claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

1. A non-shrink, irradiated packaging film comprising:
first, second, third, and fourth layers of polyamide (PA);
a first polyethylene vinyl alcohol (EVOH) layer between the first and second PA layers;
a second EVOH layer between the third and fourth PA layers;
a mid-layer between the second and third PA layers, the mid-layer comprising a polymer; and
first and second polyethylene (PE) layers, wherein the first, second, third, and fourth PA layers, the first and second EVOH layers, and the mid-layer are between the first and second PE layers.

2. A non-shrink, irradiated packaging film of claim 1, consisting essentially of the first, second, third and fourth layers of PA, the first and second EVOH layers, the EVA layer, the first and second PE layers, and, optionally, one or more tie layers.

3. A non-shrink, irradiated packaging film of claim 1,
comprising one or more tie layers.

4. The non-shrink, irradiated packaging film of claim 1, further comprising:
a first tie layer between the first PE layer and the first PA layer; and
a second tie layer between the second PE layer and the fourth PA layer.

5. The non, shrink irradiated packaging film of claim 1, wherein the mid-layer comprises ethylene vinyl acetate (EVA).

6. The non-shrink, irradiated packaging film of claim 1, wherein the packaging film has a shrink value less than 5% in both the machine direction and the transverse direction when tested according to ASTM D2732 using a bath temperature of 90 degrees Celsius.

7. The non-shrink, irradiated packaging film of claim 1, wherein the film is symmetrical.

8. The non-shrink, irradiated packaging film according to claim 1, wherein the packaging film has an oxygen transmission of less than 0.1 cm³/m²/24 hours when measured according to ASTM D3985-17, Standard Test Method for Oxygen Gas Transmission Rate Through Plastic Film and Sheeting Using a Coulometric Sensor, ASTM International, West Conshohocken, PA, 2017 within 24 hours after irradiating the packaging film.

9. The non-shrink, irradiated packaging film according to claim 1, wherein the non-shrink, irradiated packaging film has a concentration of free radicals in a range from 1×10¹⁴ spins per gram of EVOH to 1×10²⁵ spins per gram of EVOH.

10. A method comprising:
providing the non-shrink, irradiated packaging film according to claim 1;
providing a food product; and
sealing the food product in the packaging film to form a packaged food product.

11. The method of claim 10, wherein the food product has a water activity of greater than 0.6.

12. A package food product, comprising:
the non-shrink, irradiated packaging film of claim 1; and
a food product packaged in the packaging film.

13. The packaged food product of claim 12, wherein the food product is sealed in the non-shrink, irradiated packaging film.

14. The packaged food product of claim 12, wherein the food product has a water activity greater than 0.6.

15. A method for manufacturing a non-shrink, irradiated packaging film, comprising:
coextruding first, second, third, and fourth layers of polyamide (PA), first and second layers of polyethylene vinyl alcohol (EVOH); a mid-layer, and first and second polyethylene (PE) layers to produce a first film in which:
the first EVOH layer is between the first and second PA layers,
the second EVOH layer is between the third and fourth PA layers,
the mid-layer is between the second and third PA layers, and
the first, second, third, and fourth PA layers, the first and second EVOH layers, and the mid-layer are between the first and second PE layers; and
exposing the first film to ionizing radiation to produce an ionized first film.

16. The method of claim 15, comprising co-extruding a first tie layer between the first PE layer and the first PA layer; and co-extruding a second tie layer between the second PE layer and the fourth PA layer.

17. The method of claim 15, wherein the mid-layer comprises ethylene vinyl acetate (EVA).

18. The method of claim 15, wherein coextruding the layers comprises coextruding via a blown film process.

19. The method of claim 15, wherein exposing the first film to ionizing radiation comprises exposing the first film to a dose of radiation sufficient to increase a barrier property of the first film.

20. The method of claim 15, wherein exposing the first film to ionizing radiation comprises exposing the first film to electron beam radiation.
